(19) United States
(12) Patent Application Publication
(10) Pub. No.: US 2017/0098336 A1
(43) Pub. Date: Apr. 6, 2017

(54) STORAGE DOOR WITH ALARM

(71) Applicant: Motorola Mobility LLC, Chicago, IL (US)

(72) Inventors: Roger W. Ady, Chicago, IL (US); Joseph L. Allore, Mundelein, IL (US); Paul Fordham, Wauconda, IL (US); Michael Gunn, Barrington, IL (US)

(21) Appl. No.: 14/875,734

(22) Filed: Oct. 6, 2015

(51) Int. Cl. G07C 9/00; G08B 13/14; H04M 1/02; G08B 13/24

(52) U.S. Cl. CPC G07C 9/00912; G07C 9/00563; G07C 9/00087; G08B 13/2491; G08B 13/14; H04M 1/0254; G07C 2009/00095

(57) ABSTRACT

Systems and methods for secure carrying of user cards and other items are integrated with the user's portable communication device. In an embodiment, the system includes an integrated alarm function to alert the user of unauthorized access to a storage compartment. In a further embodiment, the carrying system includes a cover having electrical contacts configured for mating to the user's portable device system.

### TECHNICAL FIELD

The present disclosure is related generally to storage of personal effects for users of mobile devices, and, more particularly, to a system and method for securely storing personal effects on a mobile device.

### BACKGROUND

Although digitization has replaced many physical cards and keys previously needed for identification and business, certain functions still require a physical card, token or key. In addition, many users are still reluctant to fully trust the digital counterparts of many of their cards, keys and tokens, and thus hedge by carrying the physical items as a backup. These items included driver's licenses, workplace IDs, security tokens, keys and so on. In addition, many users carry cash for use when that is the only option.

Additionally, users generally wish to have a safe place to carry their cards and cash to insure they are not misplaced, and thus many store these cards in a wallet or purse, which is even more cumbersome to carry and access. While it may be possible to create miniature wallets or purses, this simply creates an extra item that may become lost very easily.

The present disclosure is directed to a system that can eliminate some of the shortcomings noted above. However, any such benefit is not a limitation on the scope of the disclosed principles, or of the attached claims, except to the extent expressly noted in the claims. Additionally, the discussion of technology in this Background section is reflective of the inventors' own observations, considerations, and thoughts, and is in no way intended to accurately catalog or comprehensively summarize any prior art reference or practice. As such, the inventors expressly disclaim this Background section as admitted or assumed prior art. Moreover, the identification herein of desirable courses of action reflects the inventors' own observations and ideas, and should not be assumed to indicate an art-recognized desirability.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a simplified schematic of an example device with respect to which embodiments of the presently disclosed principles may be implemented;

FIG. 2 is view of a first device and a second device (sometimes referred to herein as a “portable function module”) showing the back of the first device and the front of the second device in accordance with an embodiment of the disclosed principles;

FIG. 3 is a cross-sectional view of a portable communication device and attachable door in accordance with an embodiment of the disclosed principles;

FIG. 4 is a cross-sectional view of a retaining latch system between a portable communication device and attachable door in accordance with an embodiment of the disclosed principles;

FIG. 5 is a cross-sectional view of a switchable magnet in accordance with an embodiment of the disclosed principles; and

FIG. 6 is a flow chart illustrating a process of operating an attachable storage door and alarm system in accordance with an embodiment of the disclosed principles.

### DETAILED DESCRIPTION

Before presenting a detailed discussion of embodiments of the disclosed principles, an overview of certain embodiments is given to aid the reader in understanding the later discussion. As noted above, user's need a convenient location in which to hold the cards, keys, cash and so on that the user needs to carry. While cases are available to carry such items, the presently known solutions are not secure and require that the user carry an extra item.

In an embodiment of the disclosed principles, a secure carrying system is provided that may be integrated with the user's portable communication device. In addition, certain of the disclosed embodiments include an integrated alarm function. The carrying system in accordance with an embodiment includes a cover having electrical contacts configured for mating to a modular portable device system.

The rear cover provides other capabilities in further embodiments such as NFC (Near Field Communications) or RFID (Radio Frequency Identification) functions via embedded elements to allow the cover to act as a digital wallet as well. In one aspect, a vanity mirror may be incorporated into the back cover to provide an item that the user may otherwise need to carry.

Portable communications devices built in a modular configuration described herein can be extended as described above to include a removable rear door component that provides a pocket suitable for storing cash, credit cards, ID's, a key, etc. Since the modular configuration includes electrical contacts for communications between components, the storage door can be locked with a PIN or other authentication method such that if the back is taken off without first entering the PIN an audible alarm is triggered, and/or a remote alarm is triggered until the proper PIN is entered.

The device/storage system can also be tethered to the user with a BT (Bluetooth) proximity alarm paired with a wearable on the user to also warn the user if the user becomes too far removed from the device or when a ‘locked’ storage system door has been accessed without the proper authentication. A suitable warning could be displayed on the phone when the PIN or other authentication-based security function has been activated to deter unauthorized access.

In an embodiment, electropermanent magnets are employed on the door piece to make removal of the door very difficult when the magnet is activated, yet the door may be easily removed when the proper PIN is entered. Activation of the magnets may be sufficient to make removal difficult, or the activation could be used to operate a latch with leverage to lock securely. Similarly, solenoids, motors, or other electrically-activated locking mechanisms may be deployed to insure a secure lock to back up the alarm system.

As an aside, it will be appreciated that an electropermanent magnet is a type of magnet which consists of both an electromagnet and a dual material permanent magnet, in which the magnetic field produced by the electromagnet is used to change the magnetization of the permanent magnet. The permanent magnet consists of magnetically hard and soft materials, of which only the soft (low coercivity) material can have its magnetization changed. When the magnetically soft and hard materials have opposite magnetizations, the magnet has no net field, and when they are aligned, the magnet displays magnetic behavior. This allows the implementation of switchable permanent magnets wherein the magnetic effect can be maintained without requiring a continuous supply of electrical energy.

In addition, for NFC-enabled cards, the removable door may include an NFC reader to detect the presence or absence of any particular card in the compartment. In this way, the device is able to take an inventory every time the door is removed. In an embodiment, the same reader system can also be used as a digital wallet for POS (point of sale) transactions. For non-NFC contents or in place of an NFC-based system, the door may include a physical sensor (e.g., spring-loaded tab) or an optical sensor for detecting the content in the compartment. With such a mechanism in place, an alarm is triggered when a third party is detected to be removing contents, i.e., when the total thickness of content changes when the user is away from the location.

The definition of “away” in this case may include being greater than a prescribed distance from the device, as detected by GPS. Alternatively, the device may simply sound a reminder at prescribed intervals when the thickness decreases, until the thickness is restored.

The purpose of the NFC or thickness-based inventory checks is to help insure the user has the contents he or she needs for a given activity or to insure that if a credit card is left for payment/deposit or an ID card is taken as a deposit it is ultimately returned to the compartment.

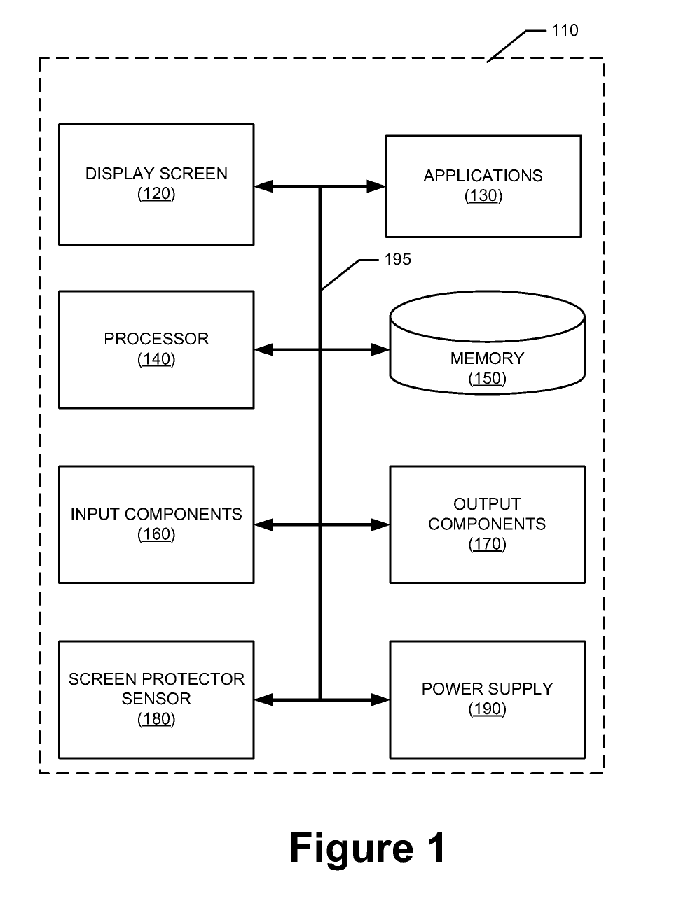

With this overview in mind, and turning now to a more detailed discussion in conjunction with the attached figures, the techniques of the present disclosure are illustrated as being implemented in a suitable computing environment. The following generalized device description is based on embodiments and examples within which the disclosed principles may be implemented, and should not be taken as limiting the claims with regard to alternative embodiments that are not explicitly described herein. Thus, for example, while FIG. 1 illustrates an example mobile device within which embodiments of the disclosed principles may be implemented, it will be appreciated that other device types may be used, including but not limited to laptop computers, tablet computers, embedded automobile computing systems and so on.

The schematic diagram of FIG. 1 shows an exemplary device 110 forming part of an environment within which aspects of the present disclosure may be implemented. In particular, the schematic diagram illustrates a user device 110 including several exemplary components. It will be appreciated that additional or alternative components may be used in a given implementation depending upon user preference, component availability, price point and other considerations.

In the illustrated embodiment, the components of the user device 110 include a display screen 120, applications (e.g., programs) 130, a processor 140, a memory 150, one or more input components 160 such as speech and text input facilities, and one or more output components 170 such as text and audible output facilities, e.g., one or more speakers.

The processor 140 may be any of a microprocessor, microcomputer, application-specific integrated circuit, or the like. For example, the processor 140 can be implemented by one or more microprocessors or controllers from any desired family or manufacturer. Similarly, the memory 150 may reside on the same integrated circuit as the processor 140. Additionally or alternatively, the memory 150 may be accessed via a network, e.g., via cloud-based storage. The memory 150 may include a random access memory (i.e., Synchronous Dynamic Random Access Memory (SDRAM), Dynamic Random Access Memory (DRAM), RAMBUS Dynamic Random Access Memory (RDRM) or any other type of random access memory device or system). Additionally or alternatively, the memory 150 may include a read only memory (i.e., a hard drive, flash memory or any other desired type of memory device).

The information that is stored by the memory 150 can include program code associated with one or more operating systems or applications as well as informational data, e.g., program parameters, process data, etc. The operating system and applications are typically implemented via executable instructions stored in a non-transitory computer readable medium (e.g., memory 150) to control basic functions of the electronic device 110. Such functions may include, for example, interaction among various internal components and storage and retrieval of applications and data to and from the memory 150.

Further with respect to the applications, these typically utilize the operating system to provide more specific functionality, such as file system service and handling of protected and unprotected data stored in the memory 150. Although many applications may provide standard or required functionality of the user device 110, in other cases applications provide optional or specialized functionality, and may be supplied by third party vendors or the device manufacturer.

With respect to informational data, e.g., program parameters and process data, this non-executable information can be referenced, manipulated, or written by the operating system or an application. Such informational data can include, for example, data that are preprogrammed into the device during manufacture, data that are created by the device or added by the user, or any of a variety of types of information that are uploaded to, downloaded from, or otherwise accessed at servers or other devices with which the device is in communication during its ongoing operation.

The device 110 further includes one or more screen protector sensors 180 configured to provide a signal indicative of the presence or absence of a screen protector on the device display screen 120. In an embodiment, as noted above, the lens cover sensors 180 include a capacitive sensor or other non-contact sensor.

In an embodiment, a power supply 190, such as a battery or fuel cell, may be included for providing power to the device 110 and its components. All or some of the internal components communicate with one another by way of one or more shared or dedicated internal communication links 195, such as an internal bus.

In an embodiment, the device 110 is programmed such that the processor 140 and memory 150 interact with the other components of the device 110 to perform a variety of functions. The processor 140 may include or implement various modules and execute programs for initiating different activities such as launching an application, transferring data and toggling through various graphical user interface objects (e.g., toggling through various display icons that are linked to executable applications).

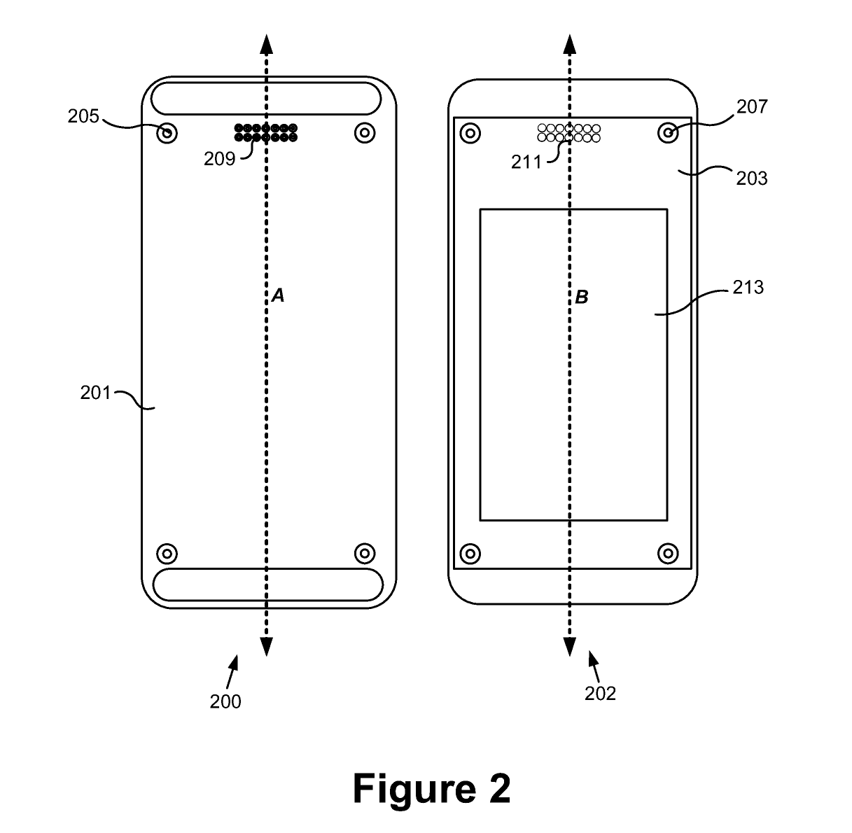

Turning to FIG. 2, this figure shows a view of the back 201 of a portable communication device 200 such as a mobile phone as well as the mating back 203 of an attachable door 202 in accordance with an embodiment of the disclosed principles. In the illustrated example, the back 201 of the portable communication device 200 includes one or more alignment features 205 configured and located to mate with mating features 207 on the back 203 of the attachable door 202.

In addition, the back 201 of the portable communication device 200 in the illustrated embodiment includes a connector array 209. The connector array 209 is located and configured to mate with a mating connector array 211 on the back 203 of the attachable door 202.

In an embodiment, the back 203 of the attachable door 202 also has a compartment 213 formed therein, such that when the back 203 of the attachable door 202 is mated to the back 201 of the portable communication device 200, the back 201 of the portable communication device 200 provides a sixth wall, closing the compartment 213.

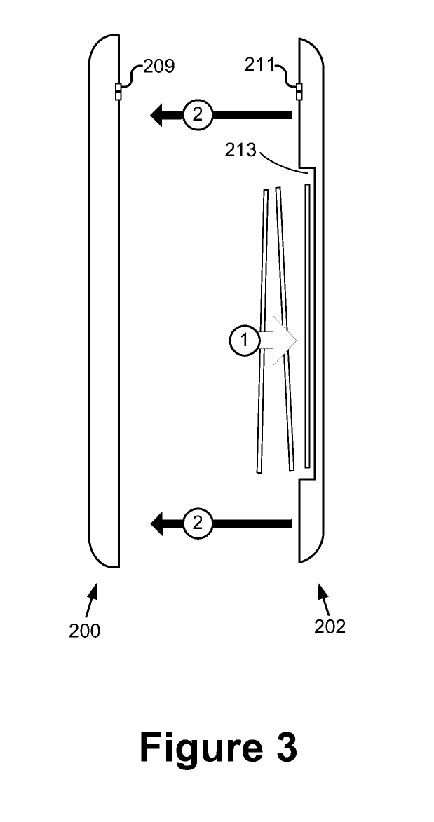

The compartment 213 can be better seen in the cross-sectional view of FIG. 3. This figure shows the portable communication device 200 in cross section, with the section being taken in a plane that is parallel to line A and perpendicular to the device back 201. Also shown is the attachable door 202 in cross-section, with the section being taken in a plane that is parallel to line B and perpendicular to the back 203 of the attachable door 202.

As can be seen, the compartment 213 in the attachable door 202 forms a closed volume when the attachable door 202 is docked against the back 201 of the portable communication device 200. The connections arrays 209, 211 also connect with one another when the attachable door 202 is docked against the back 201 of the portable communication device 200, allowing the attachable door 202 to communicate with and use the resources of the portable communication device 200.

Although not visible in these cross-sections due to the location on the devices where the cross-section is taken, one or more retaining features are also included on the attachable door 202 in an embodiment of the disclosed principles. The one or more retaining features may include one or more magnets that retain the attachable door 202 in the docked position on the portable communication device 200. While simple magnetic attraction may be sufficient to keep the devices together, it will not be sufficient to prevent unauthorized access in most cases. Although unauthorized access is detectable via an embodiment of the disclosed principles, it may also be desirable to prevent such access in the first instance to the extent possible.

Thus, in an alternative embodiment, the one or more retaining features include one or both of a latch and a switchable magnet. With respect to the former, a latch may be located on one of the devices and a mating latch plate may be located on the other. When the devices are docked together, the latch is activated to latch to the latch plate and remains latched until an authorization code or other indicia of authorization is given (e.g., voice print, finger print, etc.).

With respect to the use of switchable magnets for locking the compartment, a switchable magnet is located on one of the devices and a mating ferrous plate is located on the other. When the devices are docked together, the switchable magnet is activated to attract the ferrous plate and remains activated until an authorization code or other indicia of authorization is given (e.g., voice print, finger print, etc.). In order to avoid a continual power drain, the switchable magnets are switched via application of a current but then remain switched even with the current off until an opposite current is applied.

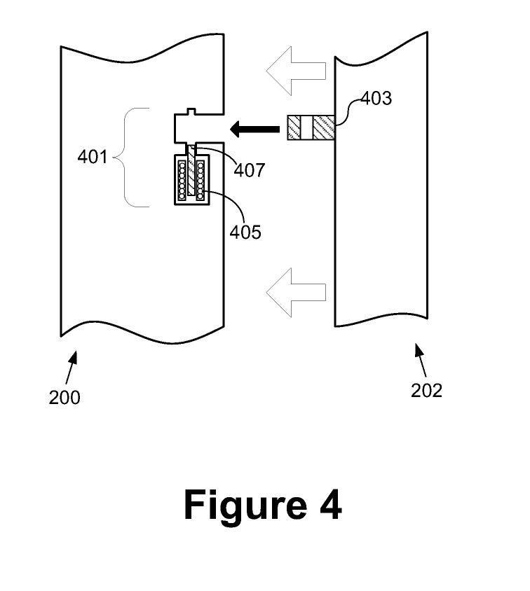

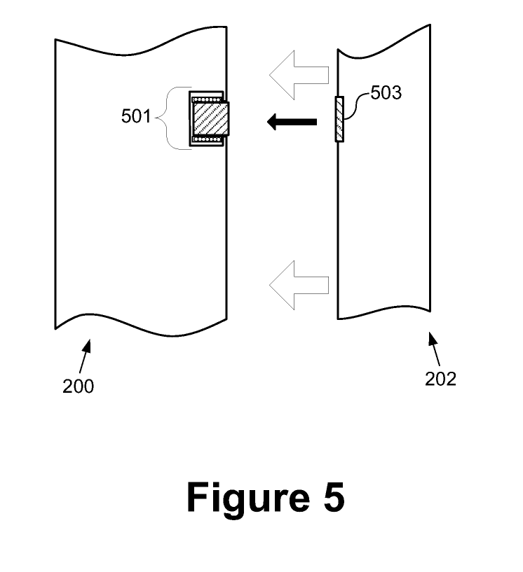

These two retaining features are shown in FIGS. 4 and 5 respectively. In particular, FIG. 4 shows a cross section of a retaining latch system. The latch system includes a solenoid-actuated latch 401 on the portable communication device 200 and a mating latch plate 403 on the attachable door 202, although it will be appreciated that these positions may be reversed. When the devices 200, 202 are docked together, the portable communication device 200 detects the docking event and activates the latch 401.

When the latch 401 is activated, a solenoid 405 pivots a clasp 407 into an opening 409 in the latch plate 403 on the attachable door 202. In this way, the attachable door 202 is secured to the portable communication device 200 until the solenoid 405 retracts the clasp 407. As noted above, the impetus for the portable communication device 200 to activate the solenoid 405 to retract the clasp 407 may be entry of an authorized password, vine print, fingerprint etc.

In an embodiment, a plurality of such latches is employed. In another embodiment, a single latch is used in conjunction with a lug on the attachable door 202 and a mating undercut slot on the portable communication device 200. In this embodiment, the lug is slid into the undercut slot and then the devices are pivoted together.

An embodiment wherein the one or more retaining features include a switchable magnet is shown in greater detail in FIG. 5. Similar to the foregoing embodiment, one portion of the retaining system resides on the portable communication device 200 and a mating portion resides on the attachable door 202. In the illustrated example, a switchable magnet 501 is located on the portable communication device 200 while a mating ferrous plate 503 is located on the attachable door 202.

In this example, when the devices are docked together, the portable communication device 200 detects the docking event and switches the switchable magnet, causing the ferrous plate 503 to be magnetically retained to the switched magnet 501. In an embodiment, a plurality of pairs of switchable magnets and ferrous plates is used.

When it is desired to detect removal of the attachable door, any of a number of mechanisms may be used. For example, in an embodiment, the portable communication device 200 detects the presence or absence of the attachable door via the device's connection array 209. In an embodiment, the attachable door 202 is configured to provide NFC or RFID functions via an embedded element, i.e., an NFC coil or an RFID antenna. This allows the attachable door 202 itself to act as a digital wallet.

In addition, an NFC or thickness-based inventory check may be used to ensure that the user has the contents he or she needs for a given activity or to ensure that any credit cards or ID cards that are taken out are ultimately returned to the compartment. For NFC-enabled cards, the attachable door 202 may include an NFC reader to detect the presence or absence of certain NFC cards in the compartment. In this way, the device 200 is able to take an inventory every time the door is removed and re-attached.

For non-NFC contents or in place of an NFC-based system, the attachable door 202 may include a physical sensor (e.g., a spring-loaded tab) or an optical sensor for detecting the content in the compartment. With such a mechanism in place, an alarm is triggered when a third party is detected to be removing contents, i.e., when the total thickness of content changes when the user is away from the location.

In an embodiment, the portable device 200 and attachable door 202 are tethered to the user with a BT (Bluetooth) proximity alarm paired with a wearable, e.g., earpiece, on the user. This allows the device 200 to warn the user via the wearable if the user becomes too far removed from the device 200 or if unauthorized access to the storage compartment is detected.

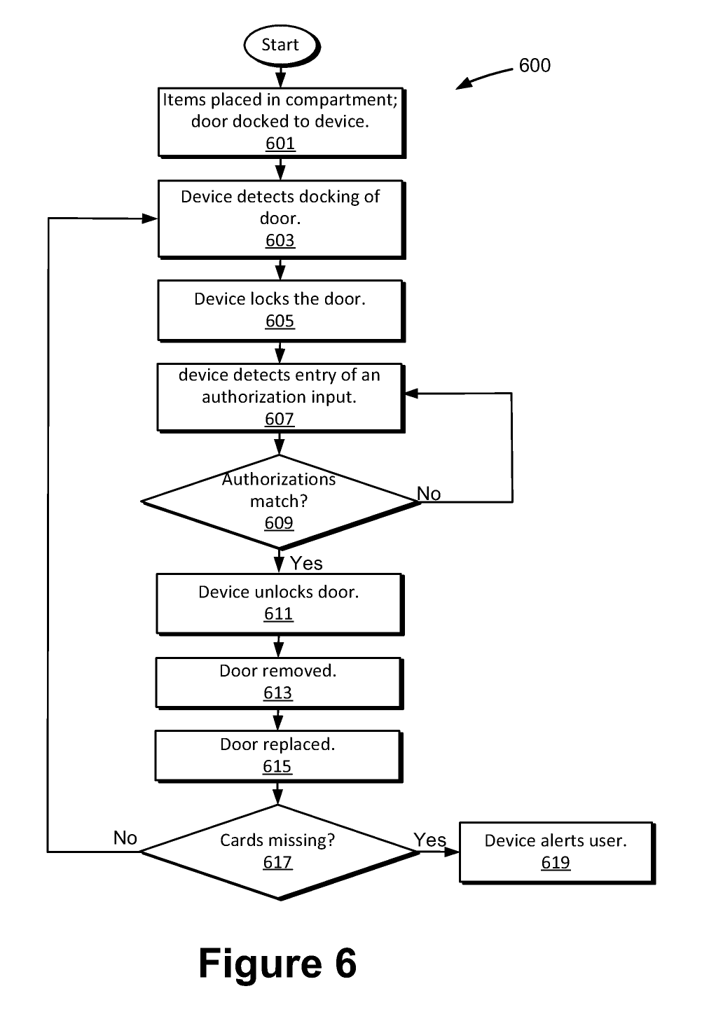

Turning to FIG. 6, this figure provides a flow chart of a process for managing user items with the disclosed system in accordance with an embodiment of the disclosed principles. At stage 601 of the process 600, the user places one or more items in the compartment of the attachable door 202 and docks the attachable door 202 to the portable communication device. The portable communication device detects the docking of the attachable door 202 at stage 603 and locks the door at stage 605, e.g., via a latch or switchable magnetic mechanism.

At stage 607, the device detects entry of an authorization input. As noted above, this authorization input may be a PIN, a spoken word or phrase, a fingerprint, etc. The device compares the entered authorization input with a stored authorization input at stage 609, and unlocks the door at stage 611 if the entered and stored authorizations match. Otherwise, the process 600 returns to stage 607 to await further input.

The door is removed at stage 613 and replaced at stage 615, whereupon the device determines if any cards are missing from the compartment at stage 617. If any cards are missing the device alerts the user at stage 619. The alert may be an audible alert, a text alert or any other suitable alerting mechanism. Otherwise, the process 600 returns to stage 603.

In an embodiment, when the attachable door is removed despite a failure of the user to enter a suitable authorization, an audible alarm is triggered, and a remote alarm may be triggered as well until the proper authorization is entered.

It will be appreciated that various systems and processes for user item management via a portable communication device and attachable door have been disclosed herein, along with methods and configurations for enabling the use of plastic display lenses in mobile devices. However, in view of the many possible embodiments to which the principles of the present disclosure may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A portable electronic communication device comprising:
an attachable door;
a front surface having a viewable display and a rear surface, the rear surface being configured to receive the attachable door, such that placement of the attachable door on the rear surface creates a closed compartment that is sized to hold one or more cards;
a retainer for holding the attachable door to the rear surface of the device; and
a processor configured to receive and verify a user authorization, and to detect detachment of the attachable door from the rear surface of the device, and to alert the user that the attachable door has been detached if an incorrect user authorization has been received or if no user authorization has been received.

2. The portable electronic communication device in accordance with claim 1, wherein the user authorization is one of a personal identification code and a biometric reading.

3. The portable electronic communication device in accordance with claim 1, wherein the biometric reading includes at least one of a fingerprint, a voiceprint, and a visual scan.

4. The portable electronic communication device in accordance with claim 1, wherein the retainer comprises one or more magnets and one or more ferrous mating plates.

5. The portable electronic communication device in accordance with claim 4, wherein the one or more magnets include one or more switchable electropermanent magnets, and wherein the processor is further configured to switch the one or more switchable electropermanent magnets to release the attachable door upon verifying that a correct user authorization has been received.

6. The portable electronic communication device in accordance with claim 1, wherein the retainer comprises an electrically activated latch.

7. The portable electronic communication device in accordance with claim 6, wherein the processor is further configured to release the electrically activated latch upon verifying that a correct user authorization has been received.

8. The portable electronic communication device in accordance with claim 1, wherein each of the device and the attachable door includes a respective connection array such that the connection arrays mate when the attachable door is attached to the device, and wherein the processor is configured to detect detachment of the attachable door from the rear surface of the device by detecting detachment of the connection arrays from one another.

9. The portable electronic communication device in accordance with claim 1, wherein the processor is further configured to inventory contents of the compartment via one or more of radio frequency identification (RFID), near field communications (NFC) and a physical sensor, and to alert the user if a previously stored card is missing.

10. The portable electronic communication device in accordance with claim 1, further comprising a Bluetooth (BT) wearable device, wherein the processor is further configured to cause an alarm to be produced at the BT wearable device if a distance between the portable communication device and the wearable BT device becomes greater than a predetermined threshold.

11. A user card management system comprising:
a portable electronic communication device;
an attachable door configured for attachment to the portable electronic communication device such that when the attachable door is attached to the portable electronic communication device, a closed compartment is formed there between and is sized to hold one or more user cards or other personal items; and
a processor configured to lock the attachable door to the portable electronic communication device until the processor detects entry of a user authorization code.

12. The user card management system in accordance with claim 11, wherein the retainer comprises one or more magnets and one or more ferrous mating plates.

13. The user card management system in accordance with claim 12, wherein the processor is configured to lock the attachable door to the portable electronic communication device by switching a switchable electropermanent magnet.

14. The user card management system in accordance with claim 13, wherein the processor is configured to switch the switchable electropermanent magnet to release the attachable door upon verifying that a correct user authorization has been received.

15. The user card management system in accordance with claim 11, wherein the processor is further configured to inventory contents of the compartment via one or more of radio frequency identification (RFID), near field communications (NFC) and a physical sensor, and to alert the user if a previously stored card is missing.

16. A method of retaining one or more user cards in association with a portable communication device comprising:
placing the one or more user cards is a compartment formed between the portable communication device and an attachable door;
locking the attachable door to the portable communication device;
receiving a user authorization; and
unlocking the attachable door from the portable communication device based on receiving the user authorization.

17. The method in accordance with claim 16, wherein unlocking the attachable door from the portable communication device based on receiving the user authorization further comprises comparing a purported user authorization with a stored user authorization to confirm the validity of the purported user authorization.

18. The method in accordance with claim 16, wherein the purported user authorization is a personal ID number.

19. The method in accordance with claim 16, wherein the purported user authorization is a biometric parameter.

20. The method in accordance with claim 16, wherein locking the attachable door to the portable communication device includes activating at least one of an electropermanent magnet and a latch.
